(19) United States
(12) Patent Application Publication
(10) Pub. No.: US 2022/0276066 A1
(43) Pub. Date: Sep. 1, 2022

(54) METHOD AND APPARATUS FOR PROVIDING COMPARATIVE ROUTING ASSOCIATED WITH ORIGIN-DESTINATION PAIRS

(71) Applicant: HERE Global B.V., Eindhoven (NL)

(72) Inventors: Jerome BEAUREPAIRE, Berlin (DE); Nicolas NEUBAUER, Berlin (DE)

(21) Appl. No.: 17/187,160

(22) Filed: Feb. 26, 2021

(51) Int. Cl. G01C 21/34

(52) U.S. Cl. CPC G01C 21/3492; G01C 21/3438; G01C 21/3423

(57) ABSTRACT

An approach is provided for providing taxi routing involving comparison among routes with and without taxi lanes. The approach involves, for example, computing a taxi route between at least one origin-destination pair using a routing engine configured to include at least one taxi lane in the taxi route. The taxi lane permits use by a taxi vehicle while restricting use by a different vehicle type (e.g., an on-demand mobility provider vehicle). The approach also involves computing a non-taxi route using the routing engine or another routing engine configured to not include the at least one taxi lane in the non-taxi route. The approach further involves providing the taxi route for the at least one origin-destination pair as an output based on a comparison of the taxi route to the non-taxi route with respect to an estimated time of arrival, a travel time, a travel distance, and/or a travel price.

### BACKGROUND

Ride hailing services have enjoyed widespread acceptance and use by consumers. The taxi industry is facing significant competition and seeking technical solutions to optimize fleet management and user experiences. For example, some taxi companies push out their own mobile applications to allow passengers to schedule rides in advance, track the taxi's progress, and pay with their smart phones. As another example, one taxi navigation service provider navigates taxies through taxi lanes. However, providing taxi lane map and/or directing taxis to taxi lanes do not guarantee faster times of arrival and/or lower costs. To the contrary, over-crowded taxi lanes can cause delay.

### SOME EXAMPLE EMBODIMENTS

Therefore, there is a need for an approach for providing taxi routing, for instance, involving comparison among routes with and without taxi lanes thereby determining optimal route(s) for a taxi and/or a taxi fleet in real-time.

According to one embodiment, a computer-implemented method comprises computing a taxi route between at least one origin-destination pair using a routing engine. The routing engine is configured to include at least one taxi lane in the taxi route, and the at least one taxi lane permits use by a taxi vehicle while restricting use by a different vehicle type (e.g., an on-demand mobility provider vehicle). The method also comprises computing a non-taxi route using the routing engine or another routing engine. The routing engine or the another routing is configured to not include the at least one taxi lane in the non-taxi route. The method further comprises providing the taxi route for the at least one origin-destination pair as an output based on a comparison of the taxi route to the non-taxi route with respect to an estimated time of arrival, a travel time, a travel distance, a travel price, or a combination thereof.

According to another embodiment, an apparatus comprises a processor, and a memory including computer program code, the memory and the computer program code configured to, with the processor, cause, at least in part, the apparatus to compute a first route between at least one origin-destination pair using a routing engine. The routing engine is configured to include at least one restricted lane in the first route, and the at least one restricted lane permits use by a first vehicle type while restricting use by a second vehicle type. The apparatus is also caused to compute a second route using the routing engine or another routing engine. The routing engine or the another routing engine is configured to not include the at least one restricted lane in the second route. The apparatus is further caused to provide the first route for the at least one origin-destination pair as an output based on a comparison of the first route to the second route with respect to an estimated time of arrival, a travel time, a travel distance, a travel price, or a combination thereof .

According to another embodiment, a computer-readable storage medium carries one or more sequences of one or more instructions which, when executed by one or more processors, cause, at least in part, an apparatus to compute taxi routes and non-taxi routes for a plurality of origin-destination pairs. Each of the taxi routes includes at least one taxi lane, each of the non-taxi routes does not include the at least one taxi lane, and the at least one taxi lane permits use by a taxi vehicle while restricting use by a different vehicle type. The apparatus is also caused to compute respective differences between the taxi routes and the non-taxi routes with respect to an estimated time of arrival, a travel time, a travel distance, a travel price, or a combination thereof. The apparatus is further caused to provide one or more pairs of the plurality of origin-destination pairs as an output based on selecting a highest difference from the respective differences, applying a difference threshold to the respective differences, or a combination thereof.

According to another embodiment, an apparatus comprises means for computing a first route between at least one origin-destination pair using a routing engine. The routing engine is configured to include at least one restricted lane in the first route, and the at least one restricted lane permits use by a first vehicle type while restricting use by a second vehicle type. The apparatus also comprises means for computing a second route using the routing engine or another routing engine. The routing engine or the another routing engine is configured to not include the at least one restricted lane in the second route. The apparatus further comprises means for providing the first route for the at least one origin-destination pair as an output based on a comparison of the first route to the second route with respect to an estimated time of arrival, a travel time, a travel distance, a travel price, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention. In one embodiment, the apparatus is further caused to present the justification message based on receiving user request following a presentation of the recommended route.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of providing taxi routing involving comparison among routes with and without taxi lanes, according to one embodiment;

FIG. 1B is a diagram of example dedicated road/lane taxi signs, according to various embodiments;

FIG. 2A is a diagram of example origin-destination (OD) matrix, according to one embodiment;

FIGS. 2B-2C are diagrams of examples routes with taxi lanes at different times of a day, according to various embodiments;

FIGS. 2D-2E are diagrams of an example flow 220 of taxi lanes, according to one embodiment;

FIG. 3 is a diagram of the components of a routing platform, according to one embodiment;

FIG. 4 is a flowchart of a process for providing taxi routing involving comparison among routes with and without taxi lanes, according to one embodiment;

FIG. 5 is a diagram of an example machine learning data matrix, according to one or more example embodiments;

FIG. 6A is a diagram of a user interface associated with a routing platform providing taxi routing involving comparison among routes with and without taxi lanes, according to one embodiment;

FIG. 6B is a diagram of a user interface displaying a taxi routing and scheduling table, according to one embodiment;

FIGS. 6C-6D are diagrams of user interfaces associated with a routing platform promoting and/or providing taxi lane routing, according to one embodiment;

FIG. 7 is a diagram of the geographic database, according to one embodiment;

FIG. 8 is a diagram of hardware that can be used to implement an embodiment;

FIG. 9 is a diagram of a chip set that can be used to implement an embodiment; and

FIG. 10 is a diagram of a user device that can be used to implement an embodiment.

### DESCRIPTION OF SOME EMBODIMENTS

Examples of a method, apparatus, and computer program for providing taxi routing involving comparison among routes with and without taxi lanes are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

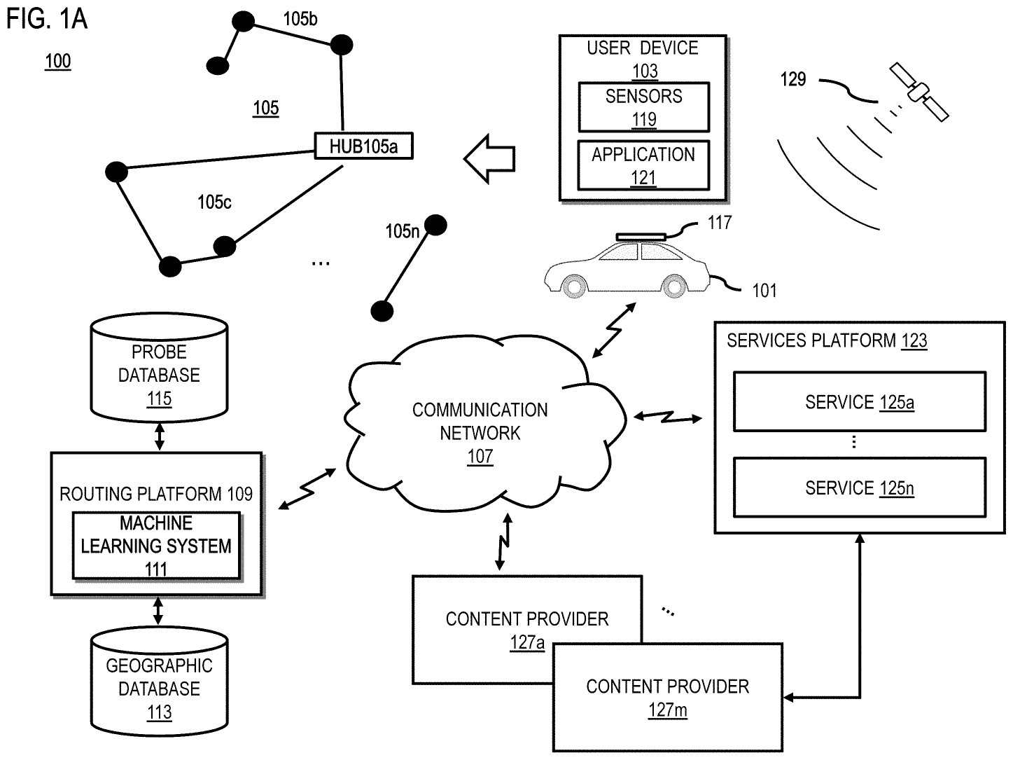

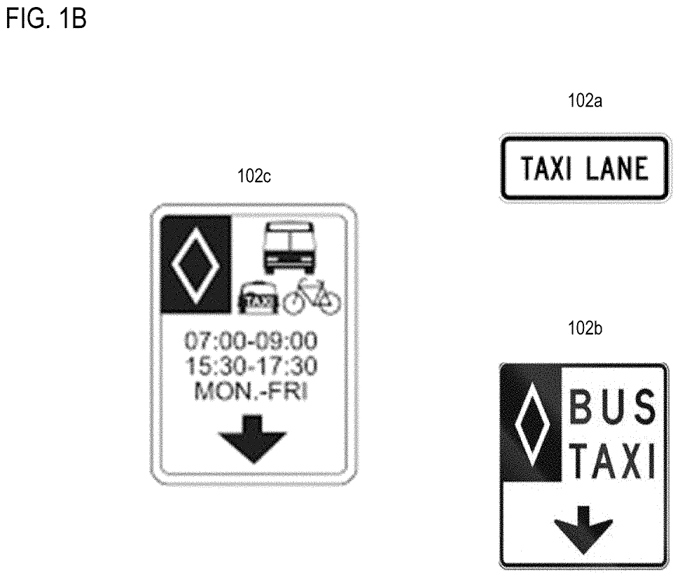

FIG. 1A is a diagram of a system capable of providing taxi routing involving comparison among routes with and without taxi lanes, according to one embodiment. As taxis usually cannot compete on prices, they are looking for other types of insights to gain customers against on-demand mobility providers. One way to get customer traction is to be able to offer a better price by using shorter/faster route to the destination.

A vehicle routing problem (VRP), or more precisely multiple vehicle routing problem (mVRP), is a combinatorial optimization and integer programming problem to determine the optimal set of routes for one or a fleet of vehicles to traverse in order to transport passengers/packages to a given set of destinations. By way of example, one or more vehicles 101 (e.g., taxis) dispatched from one or more taxi waiting areas and/or streets in the city to transport users of taxi and ride-hailing services (e.g., a user of a user device 103 such as a smartphone, personal navigation device, etc.) via a road network. The taxis operators (e.g., in Paris, France) can take advantages of taxi lanes and routes with taxi lanes which provide a competitive advantage unavailable for the on-demand mobility providers such as Uber and Lyft. For example, a road network of an area of interest can include a dedicated road/lane network 105 for the vehicles 101 (e.g., a taxi lane network) that has a hub 105a and segments 105a-105n.

The dedicated road/lane rules and signs vary among areas (e.g., cities, regions, countries, etc.). FIG. 1B is a diagram of example dedicated road/lane taxi signs, according to various embodiments. For instances, a sign 102a is for a lane dedicated for taxi only, a sign 102b is for a lane dedicated for bus and taxi, and a sign 102c is for a lane dedicated for bus, taxi, and bicycle during specific time frames, e.g., Monday via Friday 07:00-09:00 and 15:30-17:30. Additionally or alternatively, the dedicated taxi road/lane can be identified by means of road surface markings, such as colors, patterns, text, etc. The lanes can permit bus, bike and/or truck only traffic at various times of day, allowing people using those modes to move more efficiently, and to help mitigate traffic congestion. The data of the taxi lanes/roads (e.g., attributes such as locations/road segments, vehicle types, time durations, etc.) and the respective signs/surface marking (e.g., attributes such as colors, patterns, text, etc.) can be stored in a database, such as a map database. However, the existing routing algorithms either fail to consider taxi lanes, or assume taxi lanes are faster than other lanes (which can cause a congested taxi lane thus slower than a non-taxi lane). Accordingly, the taxi industry and the taxi navigation routing and mapping service providers face significant technical challenges to solve a routing problem involving taxi lanes.

To address these technical challenges, the system 100 of FIG. 1 introduces a new algorithm to provide taxi routing involving comparison among routes with and without taxi lanes, thereby determine the optimal route for a taxi. For instance, the system 100 can consider various origins (e.g., pick-up points) and destinations (e.g., drop-off points) in an area of interest such that routes with and without taxi lanes as well as their operational constraints (e.g., hours of the day) are satisfied, so as to minimize a global and/or individual transportation cost function (e.g., function based on minimizing travel distance, travel time, user preferences/requirements (e.g., wheelchair accessible), etc.) for one taxi or a fleet of taxi.

In one embodiment, the system 100 can compute and identify faster routes via using taxi lanes based on historical and/or real-time sensor data, probe data, traffic data, etc. retrieve from one or more databases via a communication network 107. By way of example, the system 100 can compute a normal duration when taking a non-taxi route and a taxi duration when taking a taxi route for each pair of an origin and a destination in an area of interest, and generate a list of data set each can be expressed as (origin, destination, normal duration, taxi duration). There are several approaches for selecting which origin/destination pairs to evaluate. For instance, the system 100 can take a top down approach, such as selecting O/D pairs in a grid or a tile (e.g., similar to quad routing). As another instance, the system 100 can take a bottom up approach, such as starting from the taxi lanes for selecting which origin/destination pairs to evaluate. As yet another instance, the system 100 can take a popularity approach, such as selecting origin/destination pairs based on the user demands/interests.

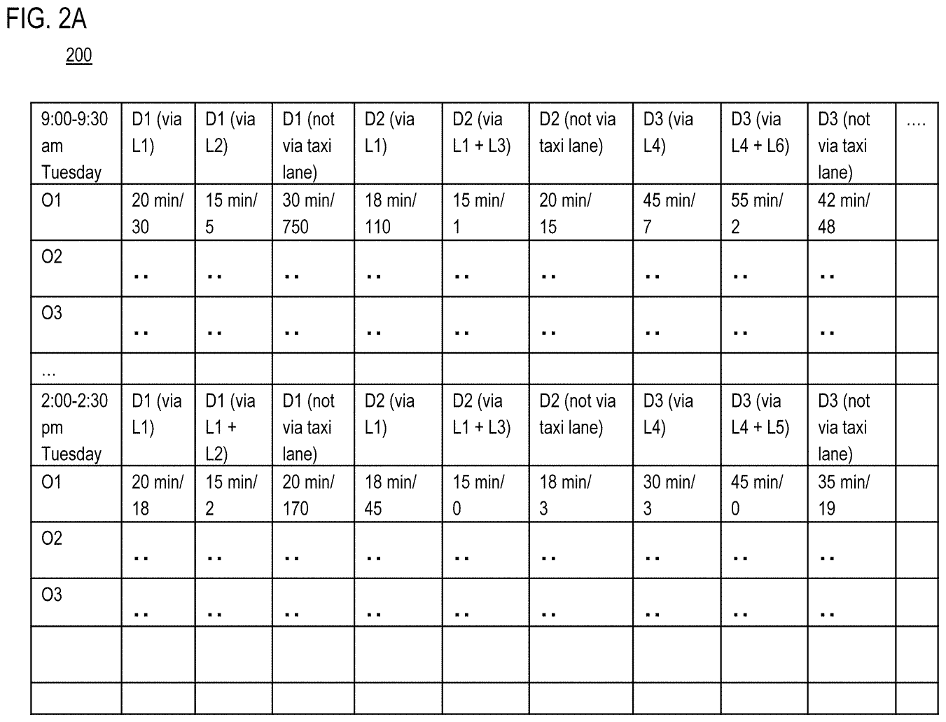

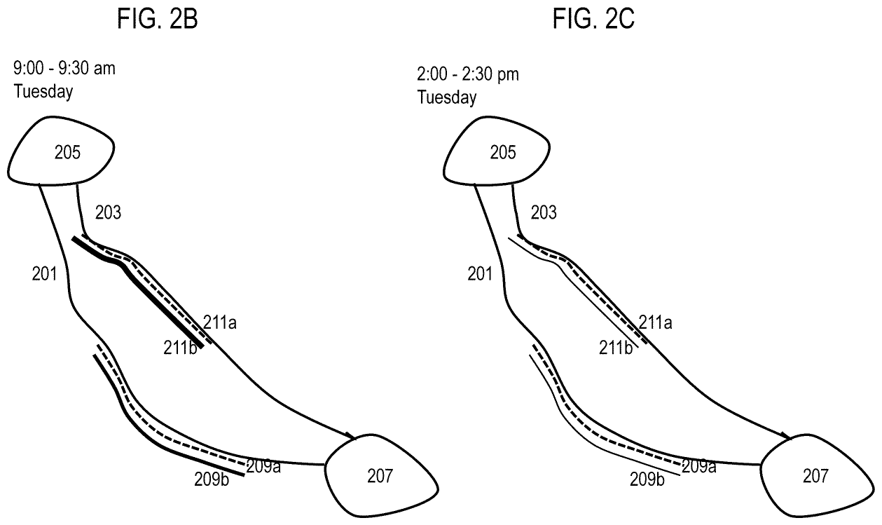

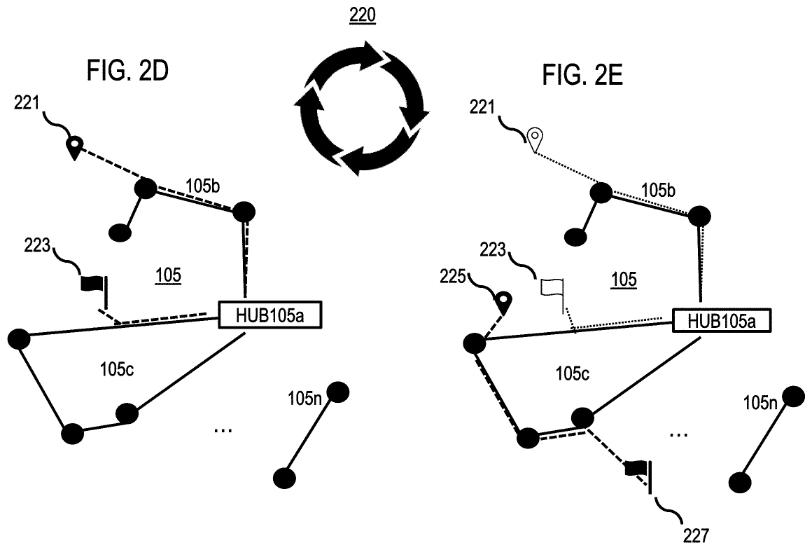

After the origin/destination pairs are selected, the system can compute the respective travel times with and without taxi lanes. FIG. 2A is a diagram of example origin-destination (OD) matrix 200, according to one embodiment. The O/D matrix 200 can list a plurality of origins O1-On and a plurality of destinations D1-Dm connected via a plurality of routes with and without taxi lanes at different time points of the day t1-tz on different days of the week, etc. in a geographic area of interest (e.g., Gothenburg, Sweden) with the computed travel times (e.g., an average travel time for all vehicles). For instances, the origins 01-On and the destinations D1-Dm can be geographic coordinates, a street corner, a parking/stopping area, a taxi waiting area, a ride-hailing area, a carpool area, a point of interest (e.g., a bus/train/ferry station, an airport terminal, a stadium, a theater district, etc.)

With the O/D matrix 200, the system 100 can determine all origin/destination areas pairs which are faster when covered by taxis than by e.g. on-demand mobility vehicles offered via Uber, etc. For example, on Tuesday between 9:00-9:30 am, the trip numbers are 785 for 01-D1, 126 for O1-D2, 57 for O1-D3, etc. The system 100 can add together total trip numbers starting from O1-On respectively, and identify the key origin areas (such as O1 with an higher trip number) to position “waiting taxis” based on the trip number and a time of the day (e.g., Tuesday between 9:00-9:30 am), as traffic varies depending on the time of the day.

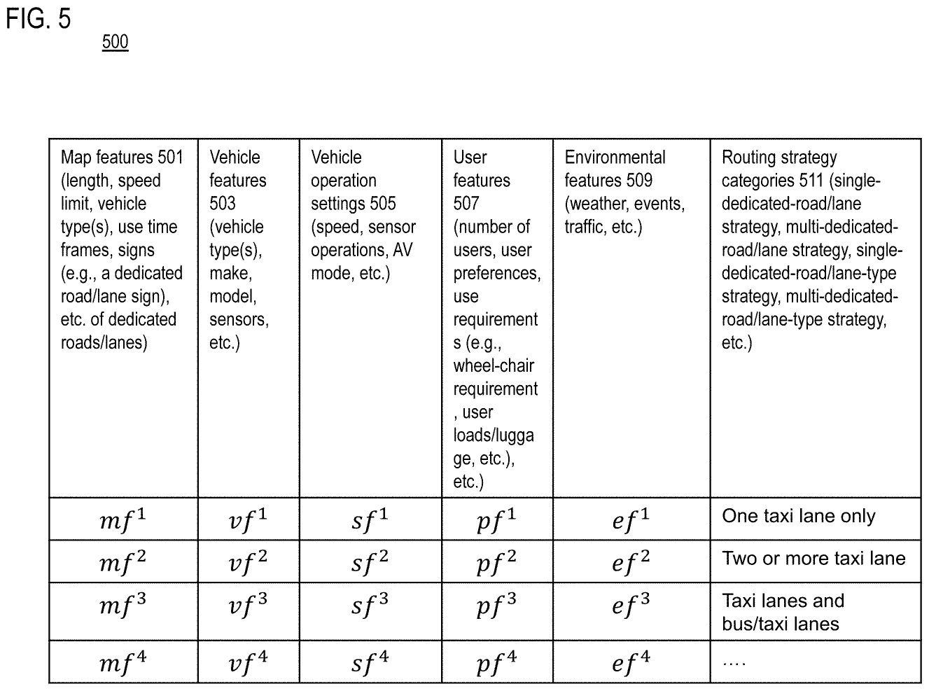

In order to make a proper comparison between the routes, the system 100 can consider the congestion levels, which vary over time. Therefore, the dimension of time is included in identifying the best O/D pairs. The more congested an area is, the more “ETA benefit” a taxi lane can bring (unless the taxi lane is congested too). Hence, the system 100 can produce origin/destination pairs that are time dependent. As shown in the O/D matrix 200 in FIG. 2A, such multi-dimensional insight is be complex and best handled via a machine learning model as later discussed in conjunction with FIG. 5.

Additionally, the system 100 can leverage population density data, mobility insights, and/or taxi distribution in the area of interest by overlaying the data on the O/D pair data to determine the origin/destination areas, taxi waiting areas, etc. By knowing which areas with taxi lanes are more populated with passengers, and/or more heavily utilized yet not currently occupied by taxis, the system 100 can recommend taxis to go to these areas more likely to pick up and/or drop off customers. By way of examples, the system 100 can consider the presence of other taxis on a taxi lane to route away a current taxi to avoid congestion and delay in the taxi lane, and the system 100 can also consider the presence of other taxis in a taxi waiting area to route away the current taxi to avoid competition. In one embodiment, the system 100 can determine taxi presence data on taxi lanes, waiting areas, etc. based on sensor data collected via vehicle-to-everything (V2X) communication, connected cars, probe data, traffic camera data, etc. By way of example, the V2X communications can incorporate more specific types of communication such as V21 (vehicle-to-infrastructure), V2N (vehicle-to-network), V2V, V2P (vehicle-to-pedestrian), V2D (vehicle-to-device), V2G (vehicle-to-grid), etc.

FIGS. 2B-2C are diagrams of examples routes with taxi lanes at different times of a day, according to various embodiments. FIG. 2B shows two routes 201, 203 with taxi lanes, where routes 201 and 203 are between an origin area 205 (e.g., O1) and a destination area 207 (e.g., D1). In this scenario, there is heavy traffic on a non-taxi lane 209b such that the average travel time per trip using the route 201 via a taxi lane 209a will save travel time. As such, the system 100 can recommend taking the route 201 via the taxi lane 209a accordingly. As there is even heavier traffic on a non-taxi lane 211b such that taking the route 203 via a taxi lane 211a will prove a bigger time saving. Therefore, the system 100 can recommend taking the route 203 via a taxi lane 211a to save more travel time. Back to the example of Tuesday between 9:00-9:30 am, the average travel time per trip between O1 and D1 is 20 minutes per 30 trips using the route 201 with a taxi lane 209a (in a broken line in FIG, 2B), 15 minutes per 5 trips using the route 203 with a taxi lane 211a (in a broken line in FIG, 2B), 30 minutes per 750 trips of routes without using any taxi lanes (such as taking routes 201, 203 via non-taxi lanes 209b, 211b in dark lines in FIG. 2B, or a different route without taxi lane (not shown) that are congested with traffic). In this scenario, the system 100 can recommend taxis waiting in O1 to utilize the route 203 with the taxi lane 211a for a shortest travel time, until the route 203 with the taxi lane 211a becomes slower than the route 201 with the taxi lane 209a and the routes without using any taxi lanes.

FIG. 2C shows the routes 201, 203 with taxi lanes, on Tuesday between 2:00-2:30 pm, when the traffic slows down in the area and without heavy traffic on the non-taxi lanes 209b and 211b. In this scenario, the average travel time per trip using the route 201 with the taxi lane 209a, using the route 203 with the taxi lane 211a, using routes without any taxi lanes do not make much travel time differences, such that taxi-lanes are not advantageous over non-taxi lanes. As such, the system 100 can recommend routes based on other factors (e.g., distances, user preferences, etc.) than the presence/absence of taxi-lanes.

After determining that there is no travel time difference between the origin area 205 and the destination area 207 whether using taxi lanes in FIG. 2C, the system 100 can check another O/D pair (not shown) in the area, and determine whether there is traffic on the respective roads with taxi lanes, and make recommendations accordingly depending on whether taxis can save more travel times over the other O/D pair. The O/D pair processing can continue until finding the optimal (i.e., most advantageous, such as a shorter travel time, a desired estimated time of arrival, a shorter travel distance, a lower travel price, etc.). The optimal origin and destination pair can vary over time, for example, depending on presence/absence of intense traffic.

In another scenario as shown in the first row of the O/D matrix 200 in FIG. 2A, the average travel time per trip between O1 and D1 during 2:00-2:30 pm is 20 minutes per 18 trips using a route with a taxi lane L1, 15 minutes per 2 trips using a route with another taxi lane L2, 20 minutes per 170 trip of routes without any taxi lanes. Since the roads are not congested with traffic, there is not much traffic differences among the taxi-lanes and non-taxi lanes, the system 100 can recommend taxis waiting in O1 to utilize the routes with or without the taxi lanes equally, until the traffic situations on the routes change.

In another embodiment, the system 100 can provide multi origin-destination planning to navigate a taxi within an optimal flow of taxi lanes. FIGS. 2D-2E are diagrams of an example flow 220 of taxi lanes, according to one embodiment. In FIG. 2D, the system 100 can dispatch or recommend a taxi to take a first segment of the flow 220 by picking up first passenger(s) from an origin 221, via as many taxi lane(s) marked with a dark broken line as possible in the taxi road/lane network 105, and dropping off at least one of the first passenger(s) at a first destination 223. Subsequently, in FIG. 2E, the system 100 can dispatch or recommend the taxi to take the next segment of the flow 220 by picking up second passenger(s) and/or dropping off at least one of the first passenger(s) from the next origin 225, via as many taxi lane(s) marked with a dark broken line as possible in the taxi road/lane network 105, and dropping off at least one of the second passenger(s) at the next destination 227.

The flow 220 can include any numbers of segments based on the taxi lane network 105, and the system 100 can provide multi origin-destination planning at the beginning at the flow 220 altogether, or one segment at a time. Computing a few trips/rides forward (i.e., multi origin-destination planning), the system 100 can consider/recommend the O-D pairs which would bring the taxi(s) to a destination area which would also be favorable for the next O-D pair, and so on. This can be achieved by selecting the next “origin” point for the taxi(s) in proximity with the first destination within a time frame of an estimated time of arrival (ETA) of the first destination, and then repeat the selection of subsequent origins and in proximity with precedent destinations within the time frame of a respective ETA of a precedent destination. Such selection can be trigged at any point of the day if the current location(s) does not seem to be the optimal one(s). In addition, the system 100 can update the dispatch and/or recommendation based on actually taken routes, real-time traffic, weather, and/or one or more other contextual factors.

In another embodiment, the system 100 can leverage the O/D computation comparison to recommend city planners/authorities where to add new taxi lanes by simulating the resulted traffic.

As used herein, the term dedicated road/lane refers to a road/lane restricted use by specific vehicle type(s) (e.g., taxis, clear-air vehicles, autonomous vehicles, etc.), vehicles meeting special requirements (e.g., carrying at least a particular number of people), including but not limited to taxi lanes, bus lanes, bike lanes, carpool lanes, high-occupancy vehicle (HOV) lanes, etc. By way of example, a taxi lane or taxi-only lane is a lane limited to taxis and is used to speed up traffic that otherwise would be held up by congestion. Although various embodiments are described with respect to taxis, it is contemplated that the approach described herein may be used with other types of vehicles that have dedicated roads/lanes and can benefit from the discussed comparison computation. For example, the system 100 can compare the areas (e.g., origins and destinations) which are much faster to reach by a bicycle than by a car due to the presence of bike lanes cutting through a park. In addition to passengers, the vehicles can be used to transport packages, etc.

In short, the system 100 can support taxi companies to identify the routes for which they have a competitive edge against the on-demand mobility providers by computing and comparing routes (with start and destination) with and without taxi lanes and highlighting the pairs with the highest estimated time of arrival (ETA) differences. Therefore, taxis can compete with on-demand vehicles by fully exploiting the value of the taxi lanes. Such approaches are applicable to other modes of transport for route or cost comparison. In addition, the system 100 can promote and optimize the use of such dedicated roads/lanes. Moreover, the system 100 can assist urban planning via defining the new dedicated roads/lanes based on the anticipated advantages, such as shorter travel time, a desired estimated time of arrival, a shorter travel distance, a lower travel price, etc.

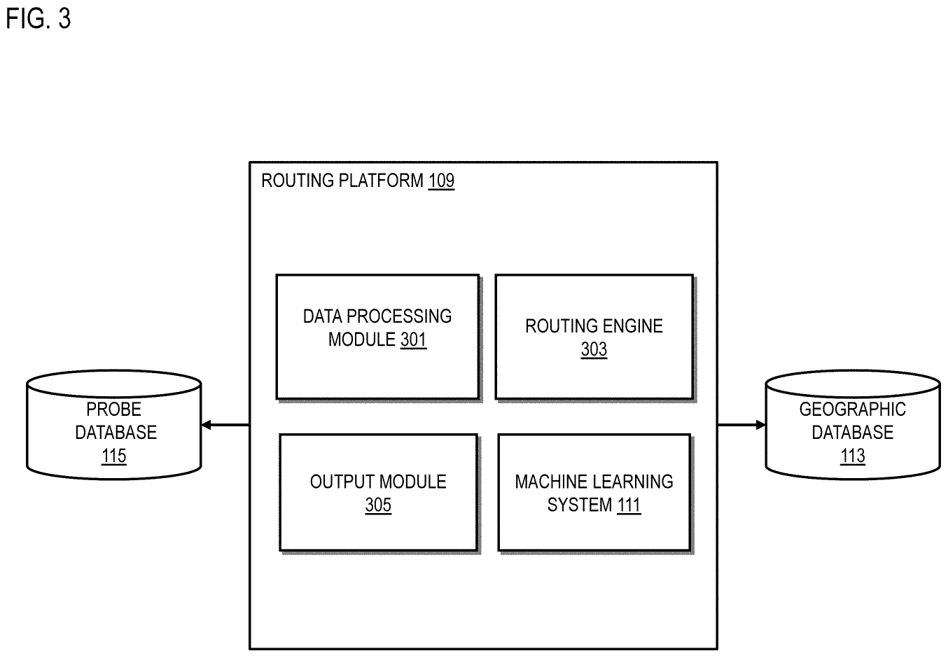

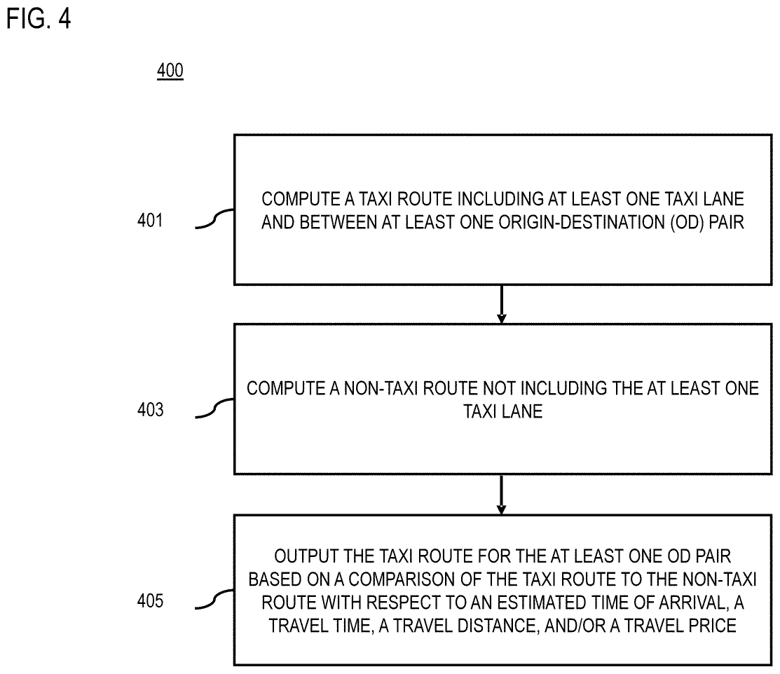

FIG. 3 is a diagram of the components of the routing platform 109, according to one or more example embodiments. In one embodiment, the routing platform 109 includes one or more components for providing taxi routing involving comparison among routes with and without taxi lanes according to the various embodiments described herein. As shown in FIG. 3, the routing platform 109 includes a data processing module 301, a routing module 303, an output module 305, and a machine learning system 111 and has connectivity to a geographic database 113 and a probe database 115 via the communication network 107. The above presented modules and components of the routing platform 109 can be implemented in hardware, firmware, software, or a combination thereof. The above presented modules and components of the routing platform 109 can be implemented in hardware, firmware, software, or a combination thereof. It is contemplated that the functions of these components may be combined or performed by other components of equivalent functionality. Though depicted as a separate entity in FIG. 1A, it is contemplated that the routing platform 109 may be implemented as a module of any of the components of the system 100 (e.g., a component of the vehicles 101 and/or the UEs 103). In another embodiment, the routing platform 109 and/or one or more of the modules 301-305 may be implemented as a cloud-based service, local service, native application, or combination thereof. The functions of the routing platform 109, the machine learning system 111, and/or the modules 301-305 are discussed with respect to FIGS. 4-7 below.

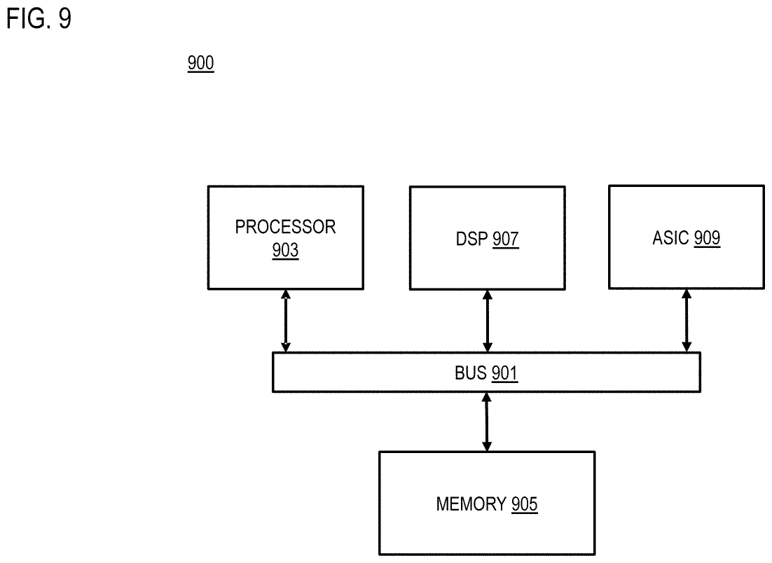

FIG. 4 is a flowchart of a process 400 for providing taxi routing involving comparison among routes with and without taxi lanes, according to one or more example embodiments. In various embodiments, the routing platform 109, the machine learning system 111, and/or any of the modules 301-305 may perform one or more portions of the process 400 and may be implemented in, for instance, a chip set including a processor and a memory as shown in FIG. 9. As such, the routing platform 109 and/or the modules 301-305 can provide means for accomplishing various parts of the process 400, as well as means for accomplishing embodiments of other processes described herein in conjunction with other components of the system 100. The steps of the process 400 can be performed by any feasible entity, such as the routing platform 109, the modules 301-305, the machine learning system 111, etc. Although the process 400 is illustrated and described as a sequence of steps, it is contemplated that various embodiments of the process 400 may be performed in any order or combination and need not include all the illustrated steps.

In one embodiment, the data processing module 301 can retrieve and/or pre-process historic and/or real-time data (e.g., traffic data including road closures, accidents, strikes, weather events, etc.) for the routing module 303 to compute optimal taxi route(s), optimal taxi waiting area(s), etc. as discussed below.

In one embodiment, in step 401, the routing module 303 can compute a taxi route between at least one origin-destination pair (e.g., O1/D1 in FIG. 2A, the origin area 207 and the destination area 209 in FIG. 2B, the origin 221 and the destination 223 in FIG. 2D, etc.) using a routing engine. For instance, the routing engine can be configured to include at least one taxi lane in the taxi route (e.g., routes including the taxi lanes 209a, 211a in FIG. 2B), and the at least one taxi lane permits use by a taxi vehicle while restricting use by a different vehicle type (e.g., an on-demand mobility provider vehicle).

In one embodiment, in step 403, the routing module 303 can compute a non-taxi route (e.g., routes including the non-taxi lanes 209b, 211b in FIG. 2B) using the routing engine or another routing engine. The routing engine or the another routing is configured to not include the at least one taxi lane in the non-taxi route.

In one embodiment, in step 405, the output module 305 can provide the taxi route for the at least one origin-destination pair (e.g., the origin area 207 and the destination area 209 in FIG. 2B) as an output based on a comparison of the taxi route to the non-taxi route with respect to an estimated time of arrival (ETA), a travel time, a travel distance, a travel price, or a combination thereof. Such comparison can be performed by any one of the modules 301-305.

In one embodiment, the routing module 303 can set thresholds for the ETA, the travel time, the travel distance, the travel price, or a combination thereof, based on context data such as taxi operator and/or user preferences (e.g., restricting 0/D pair for distances as too expensive for long ride, city limit operation areas, user preference budget limits, platform limits, etc.), etc.

In one embodiment, the at least one origin-destination pair includes an origin-destination pair set (e.g., O1/D1, O1/D2, O1/D3, . . . O2/D1, O2/D2, O2/D3, . . . O3/D1, O3/D2, O3/D3, . . . in the O/D matrix in FIG. 2A), and the routing module 303 can compute respective taxi routes and respective non-taxi routes for the origin-destination pair set, and compute respective differences between the respective taxi routes and the respective non-taxi routes with respect to the estimated time of arrival, the travel time (e.g., 20 min, 15 min, 30 min, . . . in the O/D matrix in FIG. 2A), the travel distance, the travel price, or a combination thereof.

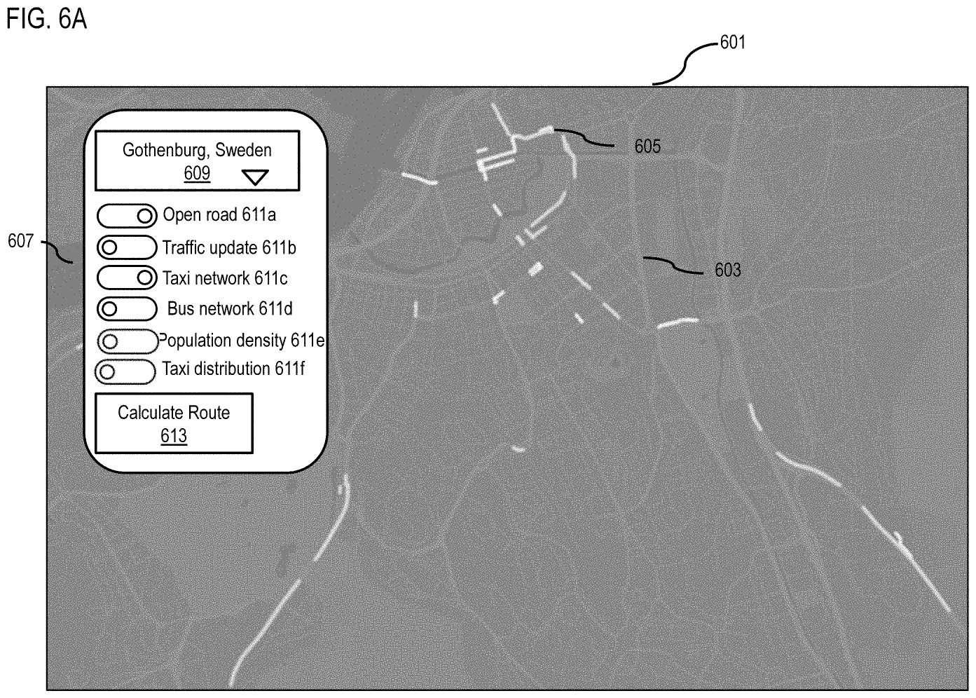

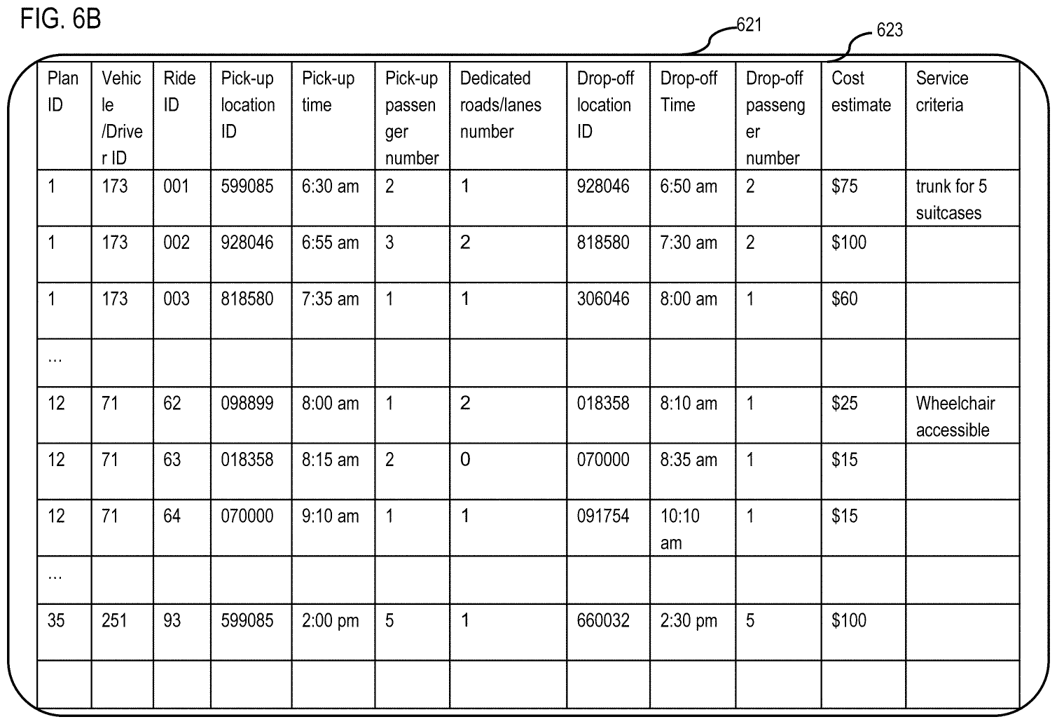

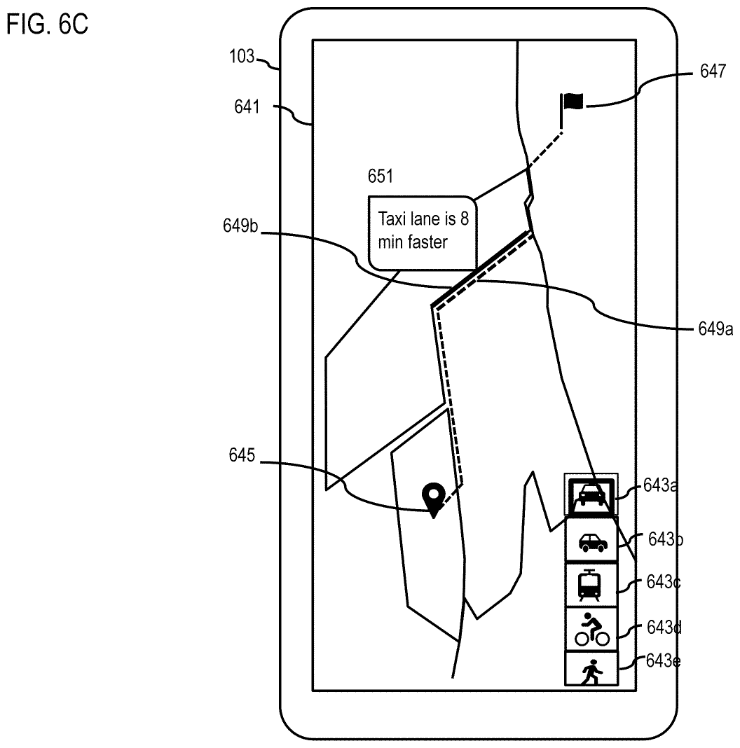

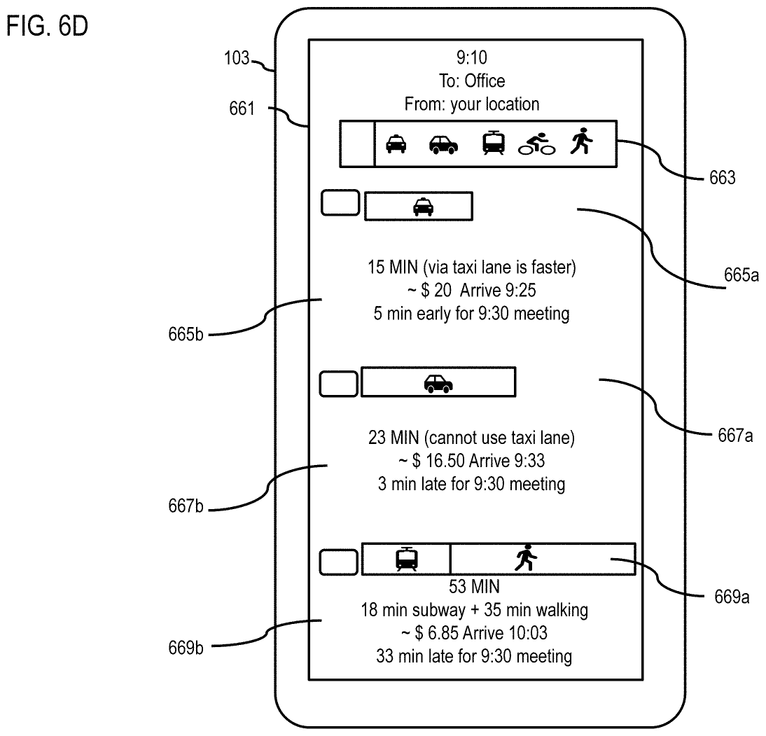

By way of example, in addition to the travel times, the O/D matrix 200 of FIG. 2A can be expended to factor in an estimated time of arrival, a travel distance, a travel price, etc., in order for the routing module 303 to compare routes based on one or more of these factors (e.g., the ETAs, costs, etc. shown in FIG. 6D). For instance, the routing module 303 can weight the origin/destination pairs by their popularity (e.g., trip numbers 30, 7, 750, . . . in the O/D matrix in FIG. 2A), total prices, etc., such that a taxi driver can wait or pass via a right location/area to get a passenger like to get the “best” ride as desired by the driver, e.g., highest income and/or an attractive destination.

In another embodiment, the routing module 303 can identify which areas that are close to taxi lanes, as the best taxi waiting areas for customers. The theoretical best scenario is to utilize a full taxi lane from start to destination. However, passengers may start from other areas different from the start and end areas of a taxi lane. The routing module 303 can apply a statistical analysis on vehicle sensor data and/or probe data to determine how far areas can be away from the taxi lane corridors as the optimal areas with higher or the highest advantage over the other vehicles such as on-demand vehicles as those offered by Uber, Lyft, etc. The routing module 303 can further consider consumer demands/preferences to determine such taxi waiting areas. For instance, the routing module 303 can determine based on the statistical analysis and/or the consumer demands/preferences that 95% of the areas which benefit most from taxi lanes are within 2 km from a taxi lane corridor, then the routing module 303 optimizes a new waiting area based on such 2 km parameter.

In yet another embodiment, the routing module 303 can compute a probability that a taxi driver will use a recommended route with a taxi lane, as sometimes the taxi driver may choose the origin of an O/D pair and/or the destination of the O/D pair depending on updates of traffic, passenger demands, etc. For instance, the taxi driver can drive to the origin of an O/D pair, and then the traffic, the passenger destination, etc. may change on the go, which results in a different destination from the destination of the O/D pair. As another instance, the traffic, passenger demands, etc. change before the taxi driver reaches the origin of an O/D pair, and the taxi driver ends up picking up another passenger near the destination of the O/D pair.

The output module 305 can then provide one or more pairs of the origin-destination pair set as part of the output based on selecting a highest difference from the respective differences, applying a difference threshold to the respective differences, or a combination thereof. Such selection/application can be performed by any one of the modules 301-305.

In one embodiment, the routing module 303 can determine a recommended sequence (e.g., a flow of taxi lanes) of the one or more pairs of the origin-destination pair set based on determining that a destination location of a first origin-destination pair will bring the taxi vehicle to within a proximity distance of an origin of a second origin-destination pair. Referring back to FIGS. 2D-2E, the flow 220 of taxi lanes can be an example of such recommended sequence of the pairs (e.g., the initial O/D pair 221, 223 in FIG. 2D, the next O/D pair 225, 227 in FIG. 2E, etc.) of the origin-destination pair set (e.g., the O/D pairs in the matrix 200 in FIG. 2A). As such, the routing module 303 can planning a few taxi trips ahead, i.e., multi origin-destination planning. By way of example, the routing module 303 can recommend a taxi driver to take a passenger from Berlin Mitte to Kreuzberg, knowing that it is likely to pick up the next customer to go to Steglitz afterwards, and then back to Charlottenburg, etc.

As mentioned, several approaches can be applied for selecting which origin/destination pairs in an area of interest to evaluate. In one embodiment, the routing module 303 can select the at least one origin-destination pair based on a grid search or a tile-based search of map data representing a geographic area of interest for a presence of the at least one taxi lane (i.e., a top down approach). For instance, the routing module 303 can search point to point at a low resolution in a digital map to identify some interesting grid cells (e.g., tiles) based on the presence of taxi lanes therein as an computing efficient approach. This approach can be less granular yet effective for a first/initial level computation to identify larger areas with taxi lanes, such as for fleet management, city planning, etc.

In another embodiment, the routing module 303 can selecting the at least one origin-destination pair based on a proximity to the at least one taxi lane (i.e., a bottom up approach). Instead of using a grid pattern for origin-destination pairs as in the top down approach, the bottom up approach can start from the taxi lanes by use locations that are likely to provide a big difference between normal and taxi durations due to their proximity to taxi lanes. This approach can be implemented for one taxi using a navigation or ride-hailing application installed in a UE 103 with online or offline data, with or without engaging a backend server.

In yet another embodiment, the routing module 303 can process historical mobility data to determine that at least one origin-destination pair based on popularity (i.e., a popularity approach weighting based on the user demands/interests). For instance, the origin and/or destination of an O/D pair can be set in large points of interest (POIs) with high occupancy/capacity, such as stadiums, transport hubs/stations, airports, theaters, shopping malls, supermarkets, etc. In another instance, the origin and/or destination of an O/D pair can be set near/around a smaller POI (e.g., a buffer area), such as a famous coffee shop, clothing store, filming location, monument, etc. Additionally or alternatively, the popularity can be further based on real-time mobility data. Such mobility data can include frequency of rides, traffic patterns, etc. associated with passengers, taxis, other on-demand vehicles, etc. in the area.

In yet another embodiment, the routing module 303 can combine these approaches to optimize the selection of the O/D pairs. For instance, the bottom-up approach can identify the O/D pairs of biggest time differences yet are likely to recommend the exact starts and ends of taxi lanes, which in turn will be connected with a user's actual origin and destination using roads without taxi lanes. However, the user may not want to travel those exact routes. The routing module 303 can offset the bottom-up approach with actual user demands, by using datasets of known popular routes/areas to identify routes which benefit most from the time differences identified via the bottom-up approach. As another instance, the routing module 303 can apply the top down approach to select large areas with more taxi lanes, and then apply the bottom up approach as offset by the popularity approach.

In one embodiment, the routing module 303 can select one or more geographic areas to pre-position the taxi vehicle or one or more other taxi vehicles based on the output.

In one embodiment, the routing module 303 can process historical mobility data to determine an optimal distance between an origin location, a destination location, or a combination of the at least one origin-destination pair and the least one taxi lane of the taxi route. For instance, the optimal distance can be based on maximizing a difference in the comparison of the taxi route to the non-taxi route (i.e., the bigger the differences, the more advantageous the taxi routes are over the non-taxi routes). In another embodiment, the optimal distance is further based on real-time mobility data.

In other embodiments, the process 400 can be broadened to cover general use cases of any mode of transport, such as referend as “first vehicle type” and “second vehicle type” as follows. For instance, the first and second vehicle types include a bicycle, a motorcycle, a bus, a taxi, a share vehicle, a ride-hailing vehicle, a truck, an ambulance, a police car, a fire truck, or a toll truck.

By way of example, the routing module 303 can compute a first route between at least one origin-destination pair (e.g., the origin area 207 and the destination area 209 in FIG. 2B) using a routing engine, wherein the routing engine is configured to include at least one restricted lane in the first route, and wherein the at least one restricted lane permits use by a first vehicle type while restricting use by a second vehicle type. The routing module 303 can further compute a second route using the routing engine or another routing engine, wherein the routing engine or the another routing engine is configured to not include the at least one restricted lane in the second route. Then the output module 305 can provide the first route for the at least one origin-destination pair as an output based on a comparison of the first route to the second route with respect to an estimated time of arrival, a travel time, a travel distance, a travel price, or a combination thereof. Such comparison can be performed by any one of the modules 301-305.

In one embodiment, the at least one origin-destination pair includes an origin-destination pair set, and the routing module 303 can compute respective first routes and respective second routes for the origin-destination pair set, and compute respective differences between the respective first routes and the respective second routes with respect to the estimated time of arrival, the travel time, the travel distance, the travel price, or a combination thereof. The output module 305 can then provide one or more pairs of the origin-destination pair set as part of the output based on selecting a highest difference from the respective differences, applying a difference threshold to the respective differences, or a combination thereof. Such selection/application can be performed by any one of the modules 301-305.

In one embodiment, the routing module 303 can determine a recommended sequence of the one or more pairs of the origin-destination pair set based on determining that a destination location of a first origin-destination pair will bring a vehicle of the first vehicle type to within a proximity distance of an origin of a second origin-destination pair.

By analogy, the routing module 303 can (1) select the at least one origin-destination pair based on a grid search or a tile-based search of map data representing a geographic area of interest for a presence of the at least one taxi lane, (2) select the at least one origin-destination pair based on a proximity to the at least one taxi lane, or (3) process historical mobility data to determine that at least one origin-destination pair based on popularity, similarly as the above-discussed top down, bottom up, and popularity approaches.

FIG. 5 is a diagram of an example machine learning data matrix 500, according to one or more example embodiments. In one embodiment, the matrix/table 500 can further include map feature(s) 501 (e.g., length, speed limit, vehicle type(s), use time frames, signs (e.g., a dedicated road/lane sign), etc. of dedicated roads/lanes), vehicle feature(s) 503 (e.g., vehicle type(s), make, model, sensors, etc.), vehicle operation setting(s) 505 (e.g., speed, sensor operations, AV/manual mode, etc.), user features 507 (e.g., number of users, user preferences, use requirements (e.g., wheel-chair requirement, user loads/luggage, etc.), etc.), environmental features 509 (e.g., visibility, weather, events, traffic, traffic light status, construction status, etc.), etc., in addition to the routing strategies 511 (e.g., single-dedicated-road/lane strategy, multi-dedicated-road/lane strategy, single-dedicated-road/lane-type strategy, multi-dedicated-road/lane-type strategy, etc.).

For example, the single-dedicated-road/lane strategy can include only one dedicated road/lane (such as one taxi lane), while the multi-dedicated-road/lane strategy can include multiple dedicated roads/lanes (such as two or more taxi lanes). As other examples, the single-dedicated-road/lane-type strategy can include only one dedicated road/lane-type (such as autonomous vehicle lanes only), while the multi-dedicated-road/lane-type strategy can include multiple dedicated roads/lanes types (such as taxi lane(s) and bus/taxi lane(s)).

In one embodiment, these routing strategy features can be derived from map data, sensor data, context data of the vehicles 101, users, the environment, etc.

By way of example, the matrix/table 500 can list relationships among features and training data. For instance, notation [symbol] mf [symbol] \hat{ }i can indicate the ith set of map features, [symbol] vf [symbol] \hat{ }i can indicate the ith set of vehicle features, [symbol] sf [symbol] \hat{ }i can indicate the ith set of vehicle operation settings, [symbol] pf [symbol] \hat{ }i can indicate the ith set of user features, [symbol] ef [symbol] \hat{ }i can indicate the ith set of environmental features, etc.

In one embodiment, the training data can include ground truth data taken from historical mobility data. For instance, in a data mining process, features are mapped to ground truth map objects/features to form a training instance. A plurality of training instances can form the training data for the routing strategy machine learning model using one or more machine learning algorithms, such as random forest, decision trees, etc. For instance, the training data can be split into a training set and a test set, e.g., at a ratio of 60%:40%. After evaluating several machine learning models based on the training set and the test set, the machine learning model that produces the highest classification accuracy in training and testing can be used (e.g., by the machine learning system 111) as the routing strategy machine learning model. In addition, feature selection techniques, such as chi-squared statistic, information gain, gini index, etc., can be used to determine the highest ranked features from the set based on the feature's contribution to routing strategy selection effectiveness.

In other embodiments, ground truth mobility data can be more specialized than what is prescribed in the matrix/table 500. For instance, the ground truth could be specific to taxi roads/lanes routing. In the absence of one or more sets of the features 501-509, the model can still function using the available features.

In one embodiment, the routing strategy machine learning model can learn from one or more feedback loops based on, for example, vehicle 101 behavior data and/or feedback data (e.g., from users), via analyzing and reflecting the actually taken routes (with and with dedicated roads/lanes), etc. The routing strategy machine learning model can learn the cause(s), for example, based on the dedicated road/lane types and/or the routing strategies, to provide routing strategies and add new objects/features into the model based on this learning.

In other embodiments, the machine learning system 111 can train the routing strategy machine learning model to select or assign respective weights, correlations, relationships, etc. among the features 501-511, to provide routing strategies and add new objects/features into the model. In one instance, the machine learning system 111 can continuously provide and/or update the machine learning models (e.g., a support vector machine (SVM), neural network, decision tree, etc.) of the machine learning system 111 during training using, for instance, supervised deep convolution networks or equivalents. In other words, the machine learning system 111 trains the machine learning models using the respective weights of the features to most efficiently select optimal action(s) to take for different dedicated road/lane types in different geographic areas.

In another embodiment, the machine learning system 111 of the routing platform 109 includes a neural network or other machine learning system(s) to update enhanced features in different bounded geographic areas. In one embodiment, the neural network of the machine learning system 111 is a traditional convolutional neural network which consists of multiple layers of collections of one or more neurons (which are configured to process a portion of an input data). In one embodiment, the machine learning system 111 also has connectivity or access over the communication network 107 to the probe database 115 and/or the geographic database 113 that can each store map data, the feature data, the outcome data, etc.

The above-discussed embodiments can be applied to increase routing efficiency and/or travel safety in any geographic areas.

In yet another embodiment, the routing module 303 can compute taxi routes and non-taxi routes for a plurality of origin-destination pairs (e.g., O1/D1, O1/D2, O1/D3, . . . O2/D1, O2/D2, O2/D3, . . . O3/D1, D3/D2, D3/D3, . . . in the O/D matrix in FIG. 2A), and each of the taxi routes (e.g., O1/D1, O1/D2, etc.) includes at least one taxi lane, each of the non-taxi routes (e.g., O1/D3) does not include the at least one taxi lane, and the at least one taxi lane permits use by a taxi vehicle while restricting use by a different vehicle type (e.g., an on-demand mobility provider vehicle). The routing module 303 can further compute respective differences between the taxi routes and the non-taxi routes with respect to an estimated time of arrival, a travel time (e.g., 20 min, 15 min, 30 min, . . . in the O/D matrix in FIG. 2A), a travel distance, a travel price, or a combination thereof. Then the output module 305 can provide one or more pairs of the plurality of origin-destination pairs as an output based on selecting a highest difference from the respective differences, applying a difference threshold to the respective differences, or a combination thereof. Such selection/application can be performed by any one of the modules 301-305.

In another embodiment, the output module 305 can perform taxi fleet management, taxi lane planning, or a combination thereof based on the output. For instance, the output module 305 can assist cities to expand their taxi lanes by simulating where each km of a new taxi lane would bring the highest benefit.

By way of example, instead of comparing travel times between two different modes of transport over a range of O/D pairs, the output module 305 can devise an averaging and weighting scheme to combine all those O/D pairs' values into a single number that shows the advantage of one mode of transport over another. This could be used for taxi-lane planning by the output module 305 via comparing different options for creating new taxi lanes based on how much improvement the new taxi lanes can bring over regular traffic.

In yet another embodiment, the output module 305 can initiate a presentation of the output on one or more user interfaces, and/or transmit the output to navigate one or more taxi vehicles (e.g., autonomous taxis). The autonomous taxis can be full self-driven or highly assisted driving (HAD) that can sense their environments and navigate within a travel network without driver or occupant input. There are proposals for autonomous vehicle dedicated lanes/roads, such that the above-discussed embodiments can applied to the autonomous vehicle dedicated lanes/roads which would bring the highest value for users boarding such autonomous vehicles versus normal vehicles not allowed on such roads/lanes.

In one embodiment, the system 100 can present/visualize taxi lanes/routes, waiting area, etc. on a user interface. FIG. 6A is a diagram of a user interface associated with a routing platform providing taxi routing involving comparison among routes with and without taxi lanes, according to one embodiment. In this example, the UI 601 shown may be generated for a UE 103 (e.g., a server of a taxi operator, a mobile device, an embedded navigation system, a client terminal, etc.) that depicts a map with open roads 603 and taxi lanes 605. The UI 601 further shows a display setting panel 607 that includes an area dropdown menu 609, a plurality of map feature display switches 611, and an input 613 of “Calculate route.” By way of example, the map feature switches 611 included open road 611a, traffic update 611b, taxi route/land network 611c, bus route/land network 611d, population density 611e, taxi distribution 611f, etc. By way of example, the traffic update 611b may include accidents, road hazards, road closures, construction events, special or public events, etc.

In this case, the area selection is Gothenburg, Sweden, and the map feature settings of the open road 611a and the taxi route/land network 611c are switched on. As such, the map shows the open roads 603 and the taxi lanes 605 in Gothenburg, Sweden.

In this instance, in response to a user (e.g., a taxi fleet management personnel, a taxi dispatcher, a driver, a passenger, a traffic planner, a city planner, etc. with different levels of data access based on credentials) interacting with the input 613, the system 100 can compute and compare open routes with and without taxi roads/lanes using, for example, the process 400. The user (e.g., the taxi dispatcher) can be a human and/or artificial intelligence. Fleet management goes beyond taxi dispatch, and further include purchasing and maintaining vehicles, registering and licensing vehicles, cutting costs and maximizing profits, etc.

In one embodiment, the system 100 can set different users with different access rights to different map features as well as different granular levels within each map feature. When the user selectively switches on the other map features, such as the traffic update 611b, the bus route/land network 611d, the population density 611e, the taxi distribution 611f, etc., the system 100 can factor in additional map feature(s) to compute and compare open routes with and without taxi roads/lanes using, for example, the process 400.

In another embodiment, the system 100 may be configured to dynamically, in real-time, or substantially in real-time, adjust large scare taxi routing based on demand and supply changes in the taxis, customers, etc. and display on the UI 601 accordingly. In yet another embodiment, the system 100 may be configured to dynamically, in real-time, or substantially in real-time, adjust taxi routing based on other contextual changes in weather, operational costs, etc.

In another embodiment, the system 100 can present/visualize areas of with “no advantages” (the opposite idea), such non-taxi lanes, not-to-wait areas, etc. on a user interface. Similar to FIG. 6A, the system 100 can highlight all areas which have no benefit for taxi drivers so they can avoid these areas.

FIG. 6B is a diagram of a user interface displaying a taxi routing and scheduling table, according to one embodiment. More specifically, FIG. 6B illustrates a user interface 621 displaying a taxi routing and scheduling table 623 that can be used in real-time by the user with different levels of data access based on credentials for taxi routing provided by the system 100. In one embodiment, Table 623 contains a daily table of one entity, e.g., a taxi service. In another embodiment, Table 623 contains a daily table of a plurality of entities which are customers of the system 100, so that a system administrator can have an overall view of all taxi rides of the area. In yet another embodiment, Table 623 contains a daily table of one entity that operates different on-demand vehicle services, including a taxi server, a ride-sharing service, etc.

By way of example, Plan 1 is assigned to Vehicle ID 173 to execute a plurality of ride throughout the day, including Ride 001 (with a cost estimate of $75) from a pick-up node ID 599085 at 6:30 am to pick up 2 passengers who need the trunk to carry 5 pieces of suitcases to travel via one taxi lane to a drop-off node ID 928046 at 6:50 am to drop off the same passengers, Ride 002 (with a cost estimate of $100) to pick-up 3 passengers from a node ID 928046 at 6:55 am to travel via two taxi lanes to a drop-off node ID 818580 at 7:30 am to drop of 2 of the passengers then the last passenger at a different location, Ride 003 (with a cost estimate of $60) to pick up one passenger from a node ID 818580 at 7:35 am to travel via one taxi lane to a drop-off the passenger at a node ID 306046 at 8:00 am.

As another example, Plan 12 is assigned to Vehicle ID 71 to execute a plurality of ride throughout the day, including Ride 062 (with a cost estimate of $25) from a pick-up node ID 098899 at 8:00 am to pick up a passenger who needs wheelchair access to travel via two taxi lanes to a drop-off node ID 018358 at 8:10, Ride 063 (with a cost estimate of $15) from the node ID 018358 at 8:15 am to travel via no taxi lane to a drop-off node ID 070000 at 8:35 am to drop off the first passenger and pick up 2 passengers, Ride 064 (with a cost estimate of $15) from the node ID 070000 at 9:10 am to travel via one taxi lane to a drop-off node ID 091754 at 10:10 am to drop of one of the two passengers and pick up a new passenger . . . .

As another example, Plan 35 is assigned to Vehicle ID 251 to execute a plurality of ride throughout the day, including Ride 93 (with a cost estimate of $100) from a pick-up node ID 599085 (e.g., an airport) at 2:00 pm to pick up 5 passengers to travel via one taxi lane to a drop-off node ID 660032 at 2:30 to drop 2 passengers at the first hotel, . . . .

The system 100 can match pick-up node IDs, drop-off node IDs, etc. to physical addresses, GPS coordinates, etc. in a database (e.g., the geographic database 113). In one embodiment, the system 100 can utilize taxi roads/lanes as much as possible, and/or set the pick-up/drop-off times/locations as close as possible to allow the taxis efficiently move from one ride to the next ride with a minimum cost that considers distance, time, fuel cost, vehicle wear and tear, etc.

Once advantageous taxi routes and areas are identified, the system 100 can promote these routes/areas via highlighting and/or recommending in navigation/ride hailing applications with specific map features showing this benefit, geofencing in the navigation/ride hailing applications showing e.g., “Guaranteed better travel time and/or price from here to your destination (e.g., an airport),” highlighting/surfacing taxi lane corridors in digital maps, local advertising in the departing/waiting areas, etc.

FIGS. 6C-6D are diagrams of user interfaces associated with a routing platform promoting and/or providing taxi lane routing, according to one embodiment. In one embodiment, the taxi lanes/roads can be presented to a user via a navigation system or application user interface (e.g., a voice-based, visual, audio, etc. user interface) to begin providing taxi routing involving comparison among routes with and without taxi lanes.

FIG. 6C is a diagram of an example user interface (UI) 641 (e.g., of a navigation application) capable of navigation with taxi roads/lanes, according to one or more example embodiments. In this example, the UI 641 shown is generated for a UE 103 (e.g., a mobile device, an embedded navigation system, a client terminal, etc.) that includes a map, transport mode icons 643, a user location 645, and a destination 647. By way of example, the transport mode icons 643 include a taxi icon 643a, an on-demand vehicle icon 643b, a subway icon 643c, a bicycle icon 643d, a walking icon 643e, etc. When the system 100 and/or the user selects the taxi icon 643a, the system 100 can compute a route with a taxi lane and the estimate time of arrival based on historical and/or real-time routing data. In this instance, the system 100 can highlight the used taxi lane 649a versus a congested non-taxi lane 649b on the same road in the UI 641. In addition, the UI 641 further shows a notice in a popup box 651: “Taxi lane is 8 minutes faster.”

FIG. 6D is a diagram of a user interface used in the processes for providing and promoting taxi lane routing, according to one embodiment. More specifically, FIG. 6D illustrates a user interface (UI) 661 that can be used in real-time by UEs 103 participating in a routing service provided by the system 100. For instance, the UE 661 presents the route options and respective information in an order as in FIG. 6D based on a cost function that factors in vehicle availability, user preferences, user context, etc. for the user to select one route option.

In this instance, as shown, the UI 661 shows a transport mode bar 663 (including taxi, one-demand vehicle, subway, cycling, and walking) and three route options with respective detailed information determined based of the afore-discussed routing mechanisms. The first route option 665a deploys a taxi and its information 665b of a travel time of 15 minutes (via taxi lane is faster) at a cost of $20 to arrive at 9:25 which is 5 min early for 9:30 meeting.

The second route option 667a deploys an one-demand vehicle (e.g., Uber) and its information 667b of a travel time of 23 minutes (cannot use taxi lane) at a cost of $16.50 to arrive at 9:33 which is 3 min late for 9:30 meeting.

The third route option 669a deploys a subway and walking and its information 669b of a travel time of 53 minutes (18 min subway +35 min walking) at a cost of $6.85 to arrive at 10:03 which is 33 min late for 9:30 meeting.

The computation of the different embodiments mentioned previously can be done partially or totally on servers/cloud, or at the edge of the network in order to balance the network load/cellular usage.

The above-discussed embodiments allow users to optimize travel efficiency by considering the most efficient and cost effective transport mode and its dedicated roads/lanes.

The advantage of the various embodiments for taxi routing is to take advantage of taxi roads/lanes via comparison among routes with and without taxi lanes, while meeting the demands and/or criteria of the customers, the ride service providers, etc. As results, the taxi operators can better compete with other on-demand vehicle providers, while the customers as a group will benefit from shorter travel times, distances, etc. to arrive at their destinations timely and more quickly, and the environment becomes better for less energy consumption from traveling shorter times/distances and/or less congested routes (e.g., assuming better routes mean less energy wasted by the vehicles 101 being stuck in congestion).

Returning to FIG. 1, although the vehicles 101 are depicted as automobiles, it is contemplated the vehicle 101 may be any type of transportation (e.g., a bicycle, a motorbike, a bus, a train, a ferry, a drone, an airplane, etc.). In one embodiment, the vehicles 101 have sensors 117 (e.g., camera sensors, light sensors, LiDAR sensors, radar, infrared sensors, thermal sensors, and the like) acquire map data, sensor data and/or probe data during operation of the vehicles 101 within the travel network for collecting context data for routing purposes.

In certain embodiments, the vehicle sensors 117 may include, for example, a global positioning sensor for gathering location data, a network detection sensor for detecting wireless signals or receivers for different short-range communications (e.g., Bluetooth, Wi-Fi, light fidelity (Li-Fi), near field communication (NFC) etc.), temporal information sensors, a camera/imaging sensor for gathering image data (e.g., for detecting objects proximate to the vehicles 101), an audio recorder for gathering audio data (e.g., detecting nearby humans or animals via acoustic signatures such as voices or animal noises), velocity sensors, and the like. In another embodiment, the vehicle sensors 117 may include sensors (e.g., mounted along a perimeter of the vehicles 101) to detect the relative distance of the vehicles 101 from any map objects/features, such as lanes or roadways, the presence of other vehicles, pedestrians, animals, traffic lights, road features (e.g., curves) and any other objects, or a combination thereof. In one scenario, the vehicle sensors 117 may detect weather data, traffic information, or a combination thereof. In one example embodiment, the vehicles 101 may include GPS receivers to obtain geographic coordinates from satellites 129 for determining current location and time. Further, the location can be determined by a triangulation system such as A-GPS, Cell of Origin, or other location extrapolation technologies when cellular or network signals are available. In another example embodiment, the one or more vehicle sensors 117 may provide in-vehicle navigation services.

In one embodiment, the UEs 103 can be associated with vehicles 101 traveling within the geographic area. By way of example, the UEs 103 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the UEs 103 can support any type of interface to the user (such as “wearable” circuitry, etc.). In one embodiment, the vehicles 101 may have cellular or wireless fidelity (Wi-Fi) connection either through the inbuilt communication equipment or from the UEs 103 associated with the vehicles 101. Also, the UEs 103 may be configured to access the communication network 107 by way of any known or still developing communication protocols.

In one embodiment, the UEs 103 include a user interface element configured to receive a user input (e.g., a knob, a joystick, a rollerball or trackball-based interface, a touch screen, etc.). In one embodiment, the user interface element could also include a pressure sensor on a screen or a window (e.g., a windshield of a vehicle 101, a heads-up display, etc.), an interface element that enables gestures/touch interaction by a user, an interface element that enables voice commands by a user, or a combination thereof. In one embodiment, the UEs 103 may be configured with various sensors 119 for collecting user sensor data and/or context data during operation of the vehicle 101 along one or more roads within the travel network. By way of example, the sensors are any type of sensor that can detect a user's gaze, heartrate, sweat rate or perspiration level, eye movement, body movement, or combination thereof, in order to determine a user context or a response to output data. In one embodiment, the UEs 103 may be configured with applications 121 (e.g., navigation applications, riad hailing applications, etc.)

In one embodiment, the routing platform 109 has connectivity over the communication network 107 to a services platform 123 that provides one or more services 125a-125n (collectively referred to as services 125) and one or more content providers 127a-127m (collectively referred to as content providers 127). In another embodiment, the services platform 123 and the content providers 127 communicate directly. By way of example, the services 125 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the content providers 127 may provide content or data (e.g., including geographic data, output data, population density data, historical mobility data, etc.). The content provided may be any type of content, such as map content, output data, audio content, video content, image content, etc. In one embodiment, the content providers 127 may also store content associated with the geographic database 113, the probe database 115, the routing platform 109, the services platform 123, the services 125, and/or vehicles 101. In another embodiment, the content providers 127 may manage access to a central repository of data, and offer a consistent, standard interface to data, such as a repository of the probe database 115 and/or the geographic database 113.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 2/3/4/5/6G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the routing platform 109 may be a platform with multiple interconnected components. By way of example, the routing platform 109 may include multiple servers, intelligent networking devices, computing devices, components, and corresponding software for providing taxi routing involving comparison among routes with and without taxi lanes. In addition, it is noted that the routing platform 109 may be a separate entity of the system 100, a part of the services platform 123, the one or more services 125, or the content providers 127.

By way of example, the vehicles 101, the UEs 103, the routing platform 109, the services platform 123, and the content providers 127 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

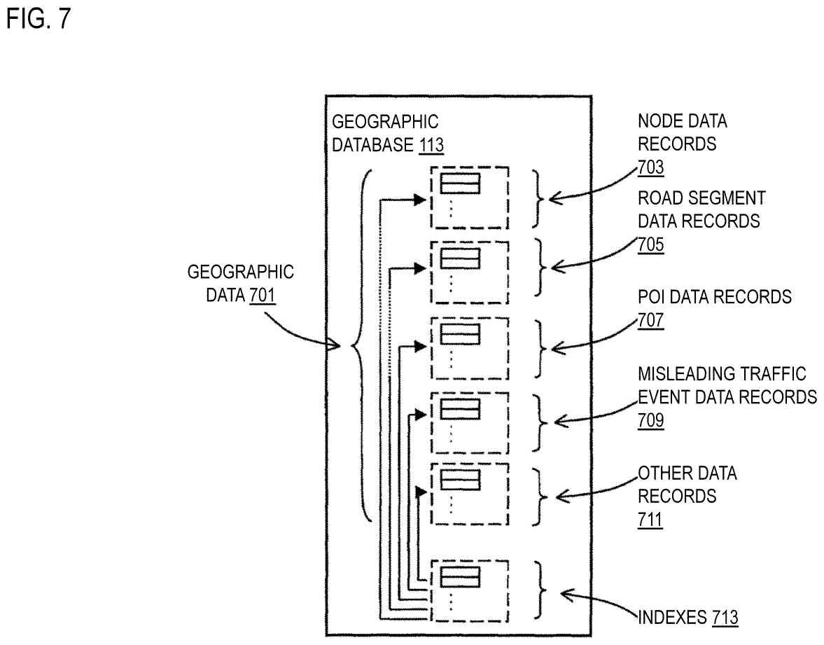

FIG. 7 is a diagram of a geographic database (such as the geographic database 113), according to one embodiment. In one embodiment, the geographic database 113 includes geographic data 701 used for (or configured to be compiled to be used for) mapping and/or navigation-related services, such as for video odometry based on the parametric representation of lanes include, e.g., encoding and/or decoding parametric representations into lane lines. In one embodiment, the geographic database 113 include high resolution or high definition (HD) mapping data that provide centimeter-level or better accuracy of map features. For example, the geographic database 113 can be based on Light Detection and Ranging (LiDAR) or equivalent technology to collect billions of 3D points and model road surfaces and other map features down to the number lanes and their widths. In one embodiment, the mapping data (e.g., mapping data records 711) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 113.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 113 follows certain conventions. For example, links do not cross themselves and do not cross each other except at a node. Also, there are no duplicated shape points, nodes, or links. Two links that connect each other have a common node. In the geographic database 113, overlapping geographic features are represented by overlapping polygons. When polygons overlap, the boundary of one polygon crosses the boundary of the other polygon. In the geographic database 113, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 113 includes node data records 703, road segment or link data records 705, POI data records 707, routing data records 709, mapping data records 711, and indexes 713, for example. More, fewer or different data records can be provided. In one embodiment, additional data records (not shown) can include cartographic (“carto”) data records, routing data, and maneuver data. In one embodiment, the indexes 713 may improve the speed of data retrieval operations in the geographic database 113. In one embodiment, the indexes 713 may be used to quickly locate data without having to search every row in the geographic database 113 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points corresponding to the respective links or segments of the road segment data records 705. The road link data records 705 and the node data records 703 represent a road network, such as used by vehicles, cars, and/or other entities. Alternatively, the geographic database 113 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 113 can include data about the POIs and their respective locations in the POI data records 707. The geographic database 113 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 113 can also include routing data records 709 for storing routing data (e.g., taxi roads/lanes data), feature data listed in FIG. 5, training data, prediction models, annotated observations, computed featured distributions, sampling probabilities, and/or any other data generated or used by the system 100 according to the various embodiments described herein. By way of example, the routing data records 709 can be associated with one or more of the node records 703, road segment records 705, and/or POI data records 707 to support localization or visual odometry based on the features stored therein and the corresponding estimated quality of the features. In this way, the routing data records 709 can also be associated with or used to classify the characteristics or metadata of the corresponding records 703, 705, and/or 707.

In one embodiment, as discussed above, the mapping data records 711 model road surfaces and other map features to centimeter-level or better accuracy. The mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 711 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 711.

In one embodiment, the mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 113 can be maintained by the content provider 127 in association with the services platform 123 (e.g., a map developer). The map developer can collect geographic data to generate and enhance the geographic database 113. There can be different ways used by the map developer to collect data. These ways can include obtaining data from other sources, such as municipalities or respective geographic authorities. In addition, the map developer can employ field personnel to travel by vehicle (e.g., vehicles 101 and/or user terminals 103) along roads throughout the geographic region to observe features and/or record information about them, for example. Also, remote sensing, such as aerial or satellite photography, can be used.

The geographic database 113 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a user terminal 103, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing taxi routing involving comparison among routes with and without taxi lanes may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

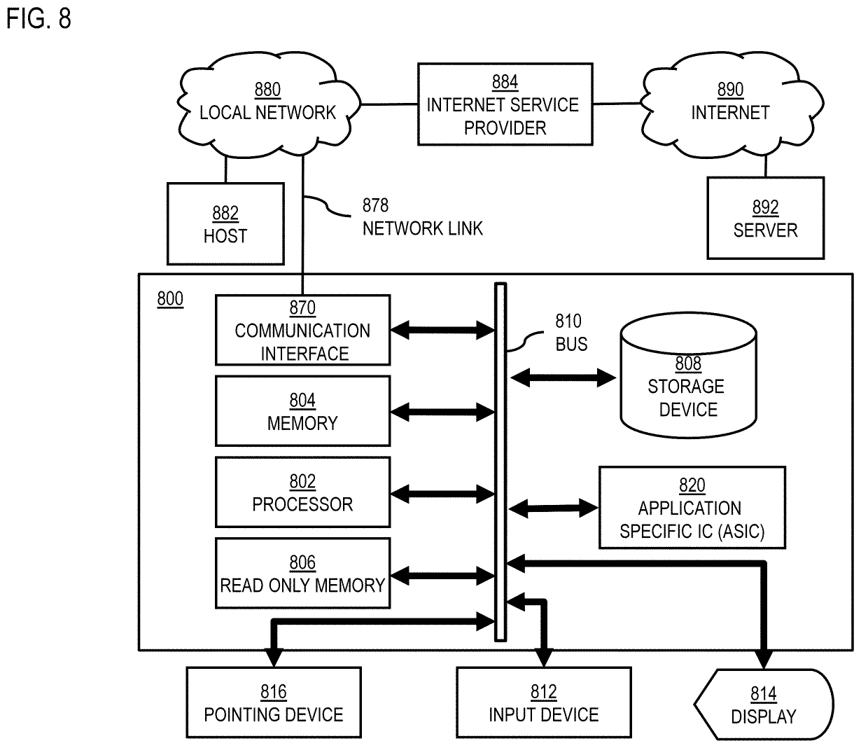

FIG. 8 illustrates a computer system 800 upon which an embodiment of the invention may be implemented. Computer system 800 is programmed (e.g., via computer program code or instructions) to provide taxi routing involving comparison among routes with and without taxi lanes as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing taxi routing involving comparison among routes with and without taxi lanes. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RANI) or other dynamic storage device, stores information including processor instructions for providing taxi routing involving comparison among routes with and without taxi lanes. Dynamic memory allows information stored therein to be changed by the computer system 800. RANI allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing taxi routing involving comparison among routes with and without taxi lanes, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for providing taxi routing involving comparison among routes with and without taxi lanes to the vehicle 101 and/or the UE 103.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to provide taxi routing involving comparison among routes with and without taxi lanes as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide taxi routing involving comparison among routes with and without taxi lanes. The memory 905 also stores the data associated with or generated by the execution of the inventive steps.

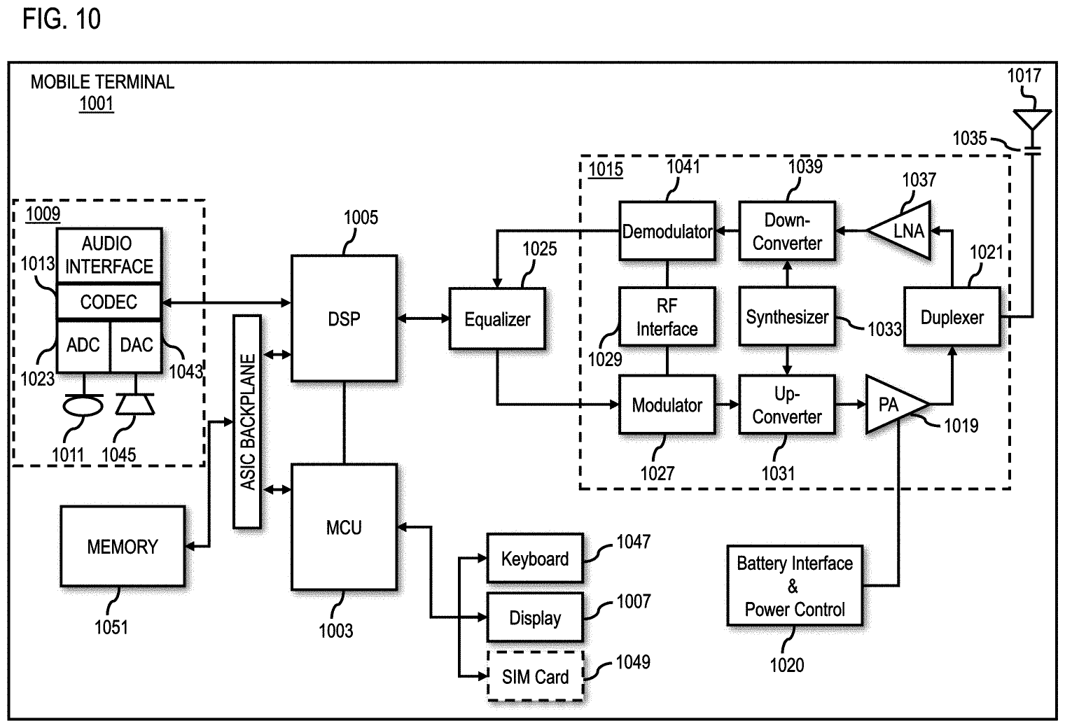

FIG. 10 is a diagram of exemplary components of a mobile terminal 1001 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to provide taxi routing involving comparison among routes with and without taxi lanes. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
computing a taxi route between at least one origin-destination pair using a routing engine, wherein the routing engine is configured to include at least one taxi lane in the taxi route, and wherein the at least one taxi lane permits use by a taxi vehicle while restricting use by a different vehicle type;
computing a non-taxi route using the routing engine or another routing engine, wherein the routing engine or the another routing is configured to not include the at least one taxi lane in the non-taxi route; and
providing the taxi route for the at least one origin-destination pair as an output based on a comparison of the taxi route to the non-taxi route with respect to an estimated time of arrival, a travel time, a travel distance, a travel price, or a combination thereof.

2. The method of claim 1, wherein the at least one origin-destination pair includes an origin-destination pair set, the method further comprising:
computing respective taxi routes and respective non-taxi routes for the origin-destination pair set;
computing respective differences between the respective taxi routes and the respective non-taxi routes with respect to the estimated time of arrival, the travel time, the travel distance, the travel price, or a combination thereof; and
providing one or more pairs of the origin-destination pair set as part of the output based on selecting a highest difference from the respective differences, applying a difference threshold to the respective differences, or a combination thereof.

3. The method of claim 2, further comprising:
determining a recommended sequence of the one or more pairs of the origin-destination pair set based on determining that a destination location of a first origin-destination pair will bring the taxi vehicle to within a proximity distance of an origin of a second origin-destination pair.

4. The method of claim 1, further comprising:
selecting the at least one origin-destination pair based on a grid search or a tile-based search of map data representing a geographic area of interest for a presence of the at least one taxi lane.

5. The method of claim 1, further comprising:
selecting the at least one origin-destination pair based on a proximity to the at least one taxi lane.

6. The method of claim 1, further comprising:
processing historical mobility data to determine that at least one origin-destination pair based on popularity.

7. The method of claim 6, wherein the popularity is further based on real-time mobility data.

8. The method of claim 1, further comprising:
selecting one or more geographic areas to pre-position the taxi vehicle or one or more other taxi vehicles based on the output.

9. The method of claim 1, further comprising:
processing historical mobility data to determine an optimal distance between an origin location, a destination location, or a combination of the at least one origin-destination pair and the least one taxi lane of the taxi route,
wherein the optimal distance is based on maximizing a difference in the comparison of the taxi route to the non-taxi route.

10. The method of claim 9, wherein the optimal distance is further based on real-time mobility data.

11. An apparatus comprising:
at least one processor; and
at least one memory including computer program code for one or more programs,
the at least one memory and the computer program code configured to, with the at least one processor, cause the apparatus to perform at least the following:
compute a first route between at least one origin-destination pair using a routing engine, wherein the routing engine is configured to include at least one restricted lane in the first route, and wherein the at least one restricted lane permits use by a first vehicle type while restricting use by a second vehicle type;
compute a second route using the routing engine or another routing engine, wherein the routing engine or the another routing engine is configured to not include the at least one restricted lane in the second route; and
provide the first route for the at least one origin-destination pair as an output based on a comparison of the first route to the second route with respect to an estimated time of arrival, a travel time, a travel distance, a travel price, or a combination thereof.

12. The apparatus of claim 11, wherein the at least one origin-destination pair includes an origin-destination pair set, and the apparatus is further caused to:
compute respective first routes and respective second routes for the origin-destination pair set;
compute respective differences between the respective first routes and the respective second routes with respect to the estimated time of arrival, the travel time, the travel distance, the travel price, or a combination thereof; and
provide one or more pairs of the origin-destination pair set as part of the output based on selecting a highest difference from the respective differences, applying a difference threshold to the respective differences, or a combination thereof.

13. The apparatus of claim 12, wherein the apparatus is further caused to:
determine a recommended sequence of the one or more pairs of the origin-destination pair set based on determining that a destination location of a first origin-destination pair will bring a vehicle of the first vehicle type to within a proximity distance of an origin of a second origin-destination pair.

14. The apparatus of claim 11, wherein the apparatus is further caused to:
select the at least one origin-destination pair based on a grid search or a tile-based search of map data representing a geographic area of interest for a presence of the at least one taxi lane.

15. The apparatus of claim 11, wherein the apparatus is further caused to:
select the at least one origin-destination pair based on a proximity to the at least one taxi lane.

16. The apparatus of claim 11, wherein the apparatus is further caused to:
process historical mobility data to determine that at least one origin-destination pair based on popularity.

17. The apparatus of claim 16, wherein the first and second vehicle types include a bicycle, a motorcycle, a bus, a taxi, a share vehicle, a ride-hailing vehicle, a truck, an ambulance, a police car, a fire truck, or a toll truck.

18. A non-transitory computer-readable storage medium carrying one or more sequences of one or more instructions which, when executed by one or more processors, cause an apparatus to at least perform the following steps:
computing taxi routes and non-taxi routes for a plurality of origin-destination pairs, wherein each of the taxi routes includes at least one taxi lane, each of the non-taxi routes does not include the at least one taxi lane, and the at least one taxi lane permits use by a taxi vehicle while restricting use by a different vehicle type;
computing respective differences between the taxi routes and the non-taxi routes with respect to an estimated time of arrival, a travel time, a travel distance, a travel price, or a combination thereof; and
providing one or more pairs of the plurality of origin-destination pairs as an output based on selecting a highest difference from the respective differences, applying a difference threshold to the respective differences, or a combination thereof.

19. The non-transitory computer-readable storage medium of claim 18, wherein the apparatus is caused to further perform taxi fleet management, taxi lane planning, or a combination thereof based on the output.

20. The non-transitory computer-readable storage medium of claim 18, wherein the apparatus is caused to further perform one or more of:
initiating a presentation of the output on one or more user interfaces, and
transmitting the output to navigate one or more taxi vehicles.
